(19) United States
(12) Patent Application Publication
(10) Pub. No.: US 2026/0195481 A1
(43) Pub. Date: Jul. 9, 2026

(54) PROGRAM, INFORMATION PROCESSING APPARATUS, AND INFORMATION PROCESSING METHOD

(71) Applicant: SONY GROUP CORPORATION, TOKYO (JP)

(72) Inventors: JUN YOKONO, TOKYO (JP); TATSUHITO SATO, TOKYO (JP)

(21) Appl. No.: 19/133,516

(22) PCT Filed: Oct. 24, 2023
(86) PCT No.: PCT/JP2023/038344

§ 371 Date: May 28, 2025

(30) Foreign Application Priority Data
Dec. 5, 2022 (JP) 2022-194066

(51) Int. Cl. G06F 21/62

(52) U.S. Cl. CPC G06F 21/6245

(57) ABSTRACT

To improve protection performance of personal information when handling a feature amount including the personal information.

A program for causing a computer to function as: a communication unit that acquires, for each of a plurality of feature amounts, first partial feature amounts including a feature amount component having a same dimension and different from a dimension of a feature amount component included in a second partial feature amount acquired by another information processing apparatus, the second partial feature amount being different from an information processing apparatus configured by the computer; and a calculation unit that calculates, for each of the plurality of first partial feature amounts acquired by the communication unit, a first value representing a relationship with a first reference point for determining a cluster feature amount that is a feature amount of a cluster of the plurality of feature amounts.

### TECHNICAL FIELD

The present disclosure relates to a program, an information processing apparatus, and an information processing method.

### BACKGROUND ART

In recent years, a technology for utilizing a feature amount including personal information has been developed. For example, a user is generally identified by determining whether or not a feature amount acquired from a face image of the user is similar to a user feature amount registered in advance for identifying the user.

On the other hand, various technologies for protecting personal information when a feature amount including the personal information is processed by an information processing apparatus have been developed. For example, Patent Document 1 discloses a technique for protecting personal information by assigning identification information associated with position information of data to each of image data capable of identifying an individual or data obtained by dividing video data, and transmitting the data to a server (information processing apparatus).

### CITATION LIST

### Patent Document

Patent Document 1: Japanese Patent Application Laid-Open No. 2008-98768

### SUMMARY OF THE INVENTION

### Problems to be Solved by the Invention

However, in a case where one information processing apparatus acquires a feature amount including personal information in processing of handling the feature amount, there is a possibility that the personal information of the user is not protected. For example, in the technology disclosed in Patent Document 1 described above, since one information processing apparatus holds divided data, there is a possibility that personal information is not protected due to restoration of data of a division source on the basis of the divided data.

Therefore, the present disclosure proposes a new and improved technology capable of improving the protection performance of personal information when handling a feature amount including personal information.

### Solutions to Problems

According to the present disclosure, there is provided a program for causing a computer to function as: a communication unit that acquires, for each of a plurality of feature amounts, first partial feature amounts including a feature amount component having a same dimension and different from a dimension of a feature amount component included in a second partial feature amount acquired by another information processing apparatus, the second partial feature amount being different from an information processing apparatus configured by the computer; and a calculation unit that calculates, for each of the plurality of first partial feature amounts acquired by the communication unit, a first value representing a relationship with a first reference point for determining a cluster feature amount that is a feature amount of a cluster of the plurality of feature amounts.

Furthermore, according to another aspect of the present invention to solve the above problem, there is provided an information processing apparatus including: a communication unit that acquires, for each of a plurality of feature amounts, first partial feature amounts including a feature amount component having a same dimension and different from a dimension of a feature amount component included in a second partial feature amount acquired by another information processing apparatus; and a calculation unit that calculates, for each of the plurality of first partial feature amounts acquired by the communication unit, a first value representing a relationship with a first reference point for determining a cluster feature amount that is a feature amount of a cluster of the plurality of feature amounts.

Furthermore, according to another aspect of the present invention to solve the above problem, there is provided an information processing method executed by a computer, the method including: acquiring, for each of a plurality of feature amounts, first partial feature amounts including a feature amount component having a same dimension and different from a dimension of a feature amount component included in a second partial feature amount acquired by another information processing apparatus, the second partial feature amount being different from an information processing apparatus configured by the computer; and calculating, for each of the plurality of first partial feature amounts acquired, a first value representing a relationship with a first reference point for determining a cluster feature amount that is a feature amount of a cluster of the plurality of feature amounts.

### BRIEF DESCRIPTION OF DRAWINGS

FIG. 1 is an explanatory diagram of an outline of an information processing system according to the present disclosure.

FIG. 2 is a flowchart illustrating an example of a flow of updating a user feature amount of a device 10 and a server S according to the present embodiment.

FIG. 3 is an explanatory diagram for explaining an example of generation and transmission of a partial feature amount to the server S by the device 10.

FIG. 4 is a block diagram illustrating an example of a configuration of the server S according to the present embodiment.

FIG. 5 is an explanatory diagram for explaining an example in which a cluster ID is temporarily allocated by a server S1 according to a first operation example.

FIG. 6 is an explanatory diagram for explaining an example in which a calculation unit 221 of the server S1 calculates a distance between a first partial feature amount f1 and a first center point c1.

FIG. 7 is an explanatory diagram for explaining an example in which a calculation unit 221 of a server S2 calculates a distance between a second partial feature amount f2 and a second center point c2.

FIG. 8 is an explanatory diagram for explaining an example in which the calculation unit 221 of the server S1 calculates an integration distance and allocates a provisional cluster C to a feature amount F.

FIG. 9 is an explanatory diagram for explaining an example in which the device 10 determines a user feature amount for each cluster.

FIG. 10 is a sequence diagram illustrating an example of a flow of the first operation example according to the present embodiment.

FIG. 11 is an explanatory diagram for explaining an example in which the server S1 and the server S2 calculate a center point of the partial feature amount belonging to the cluster.

FIG. 12 is an explanatory diagram for explaining a distribution of feature amounts F.

FIG. 13 is an explanatory diagram for explaining an example in which the calculation units 221 of the server S1 and the server S2 calculate distances between each partial feature amount and each center point.

FIG. 14 is an explanatory diagram for explaining an example in which the calculation unit 221 of the server S1 determines a combination of a first center point c1 and a second center point c2 for determining a user feature amount by calculating an integration distance.

FIG. 15 is a sequence diagram illustrating an example of a flow of a second operation example according to the present embodiment.

FIG. 16 is an explanatory diagram for explaining an example in which each of the calculation units 221 of the server S1 and the server S2 calculates a distance between each partial feature amount and another partial feature amount.

FIG. 17 is an explanatory diagram for explaining an example in which the calculation unit 221 of the server S1 calculates an integration distance and allocates a cluster to each feature amount F.

FIG. 18 is an explanatory diagram for explaining a method of determining cluster allocation of each feature amount F.

FIG. 19 is a sequence diagram illustrating an example of a flow of a third operation example according to the present embodiment.

FIG. 20 is a block diagram illustrating an example of an information processing apparatus 90.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configuration are denoted by the same reference numerals, and redundant description is omitted.

In addition, in the present specification and the drawings, a plurality of components having substantially the same functional configuration may be distinguished by attaching different numbers after the same reference numerals. However, in a case where it is not necessary to particularly distinguish each of the plurality of components having substantially the same functional configuration, only the same reference numeral is attached to each of the plurality of components.

Note that the description will be given in the following order.
1. Outline of information processing system according to embodiment of the present disclosure
2. Functional configuration example of server S according to present embodiment
3. Operation example according to present embodiment
3-1. First operation example
3-2. Second operation example
3-3. Third operation example
4. Hardware configuration
5. Additional notes

### <<1. Overview of Information Processing System According to Embodiment of Present Disclosure>>

An embodiment of the present disclosure relates to an information processing system including an information processing apparatus capable of improving protection performance of personal information when handling a feature amount including personal information. The feature amount handled by the information processing system according to the embodiment of the present disclosure is, for example, a feature amount obtained from a face image, an attribute such as age, gender, or race, medical data in a disease or medical examination, data such as revenue or past credit history, voice data for speaker identification, speaker feature data, or the like, and is not particularly limited. In the present embodiment, an example in which the feature amount handled by the information processing apparatus is a feature amount extracted from a face image will be described.

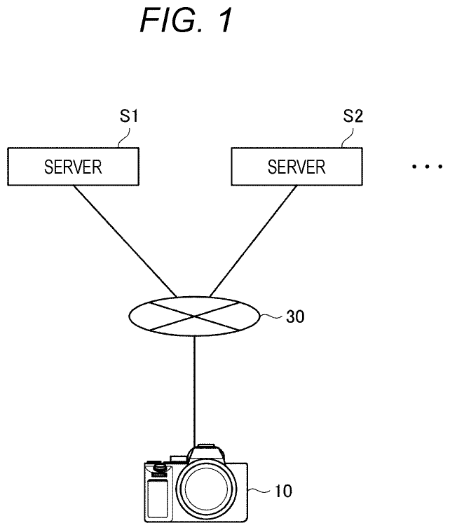

First, a schematic configuration of an information processing system according to an embodiment of the present disclosure will be described with reference to FIG. 1. FIG. 1 is an explanatory diagram of an outline of the information processing system according to the present disclosure. As illustrated in FIG. 1, the information processing system according to the present disclosure includes a device 10 and a plurality of servers S (servers S1 and S2). As illustrated in FIG. 1, the device 10 and the servers S are configured to be communicable via a network 30. The number of servers S may be at least two or more, and may be arbitrarily set according to the number of dimensions of the feature amount components constituting the feature amount. In the present embodiment, an example in which the information processing system includes the server S1 and the server S2 will be described.

The device 10 is a device such as a camera that images a person to acquire the image of the person. The device 10 may image a person on the basis of a user operation. Furthermore, the device 10 may be configured as a part of a robot or the like, and may automatically image a person on the basis of control by the robot.

At the time of imaging, the device 10 determines whether or not a person present within the imaging range is a registered user. Specifically, the device 10 extracts a face image of a person from the acquired image and calculates a feature amount of the face image. Then, the device 10 calculates a value indicating a relationship between the calculated feature amount and the user feature amount indicating the feature of the registered user held in the storage unit included in the device 10. At this time, in a case where it is determined that the calculated value satisfies the condition and the feature amount of the face image and the user feature amount are in a similar relationship, the device 10 determines that the person appearing in the image is the registered user.

Here, depending on an imaging environment such as brightness of an imaging place or a state of the user such as an expression of the user, there is a case where the value does not satisfy the condition even if the person appearing in the image is the registered user. Therefore, even in a case where the value does not satisfy the condition, in a case where the device 10 acquires a plurality of images temporally continuously, it is determined by another means whether or not the person appearing in the image is the registered user. Specifically, the device 10 may track the face of the person determined to be the already registered user between a plurality of temporally consecutive images. Then, the device 10 may determine that the tracked person appearing in the image is the registered user.

It is conceivable that a plurality of user feature amounts exists for one user according to an imaging environment such as brightness of an imaging place where the user exists, or a state of the user such as wearing of a wear such as glasses or a hat, a hairstyle, or an expression. Furthermore, it is also conceivable that the user feature amount changes as the user grows or ages.

Therefore, the device 10 updates the user feature amount held in the storage unit to a user feature amount newly calculated on the basis of the feature amount of the acquired face image, or adds the newly calculated user feature amount to the storage unit, thereby enhancing the recognition accuracy of the user. In the present embodiment, an example in which the device 10 updates the user feature amount held in the storage unit to a newly calculated user feature amount (hereinafter, it is also simply referred to as “new user feature amount”) will be mainly described. Here, the new user feature amount is calculated on the basis of clustering of the feature amounts of the face image by the server S. The user feature amount is an example of a cluster feature amount that is a feature amount representing a cluster. The server S is an example of an information processing apparatus that calculates a new user feature amount. The server S may be configured on a cloud computer.

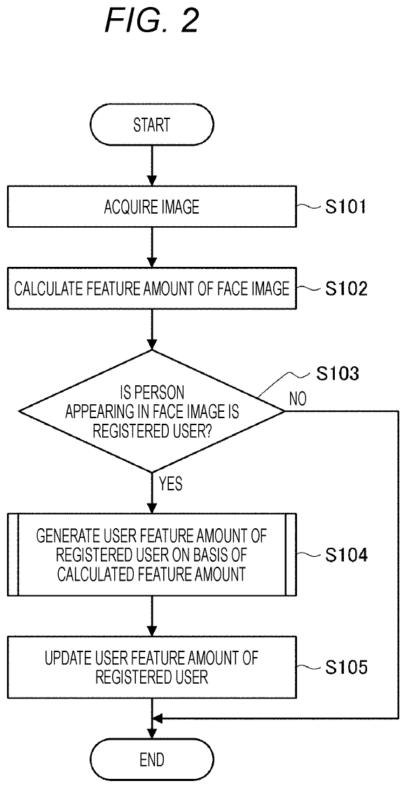

The flow of updating the user feature amount described above will be organized using the flowchart of FIG. 2. FIG. 2 is a flowchart illustrating an example of a flow of updating the user feature amount by the information processing system according to the present embodiment.

First, the device 10 included in the information processing system according to the present embodiment images a person to acquire an image of the person (S101). The device 10 calculates a feature amount of the face image extracted from the image of the person (S102). Subsequently, the device 10 determines whether or not the person appearing in the face image is a registered user on the basis of the calculated feature amount and tracking of temporally continuously acquired images (S103).

In a case where the device 10 determines that the person appearing in the face image is not the registered user (S103/NO), the device 10 ends the processing. On the other hand, in a case where the device 10 determines that the person appearing in the face image is the registered user (S103/YES), the server S included in the information processing system according to the present embodiment generates a new user feature amount of the registered user on the basis of the feature amount calculated by the device 10 and clustering related to a plurality of feature amounts indicating the registered user (S104). The device 10 updates the user feature amount held in the storage unit to a new user feature amount generated by the server S, and ends the processing (S105).

### (Review of Problems)

Although it is conceivable that the generation of the new user feature amount executed by the server S in S104 of the flowchart illustrated in FIG. 2 is performed by the device 10, it is necessary to secure a memory area in order to process a large amount of feature amounts in the device 10. Furthermore, depending on the processing performance of the device 10, it takes a lot of time to generate the user feature amount. Therefore, the generation of the new user feature amount is performed by the server S.

Here, as a comparative example of the present disclosure, it is conceivable that one server receives the feature amount of the face image from the device 10 and calculates the user feature amount at the time of generating a new user feature amount in S104 of the flowchart illustrated in FIG. 2. However, when the face image is restored from the feature amount of the face image received by the server, there is a possibility that the personal information is leaked. Furthermore, it is conceivable to encrypt the feature amount of the face image and transmit the encrypted feature amount to the server, but it is also conceivable that there is a possibility that decryption of the encrypted feature amount leads to leakage of personal information.

Therefore, the plurality of servers S in the present disclosure performs processing for determining the user feature amount using the partial feature amount including a part of the feature amount. First, the device 10 according to the present disclosure generates a plurality of partial feature amounts to be transmitted to each of the plurality of servers S from the calculated feature amounts. More specifically, the device 10 generates the plurality of partial feature amounts such that the dimensions of the feature amount components included in each of the plurality of partial feature amounts are different from each other for the feature amounts including the multi-dimensional feature amount components. Here, the device 10 may generate the partial feature amount such that all the feature amount components included in the feature amount are included in any of the plurality of partial feature amounts. For example, the device 10 generates a partial feature amount including one-dimensional to N/2-dimensional feature amount components and a partial feature amount including N/2+one-dimensional to N-dimensional feature amount components from the feature amount including the N-dimensional feature amount components. Furthermore, the device 10 may generate the partial feature amount after reducing the dimension of the feature amount.

In the present embodiment, an example in which the device 10 transmits a first partial feature amount, which is an example of a partial feature amount, to the server S1 and transmits a second partial feature amount, which is an example of a partial feature amount, to the server S2 will be described. The device 10 generates the partial feature amounts such that the dimensions of the feature amount components of the partial feature amounts transmitted to the same server S are the same for each of the plurality of feature amounts having the same number of dimensions of the feature amount components.

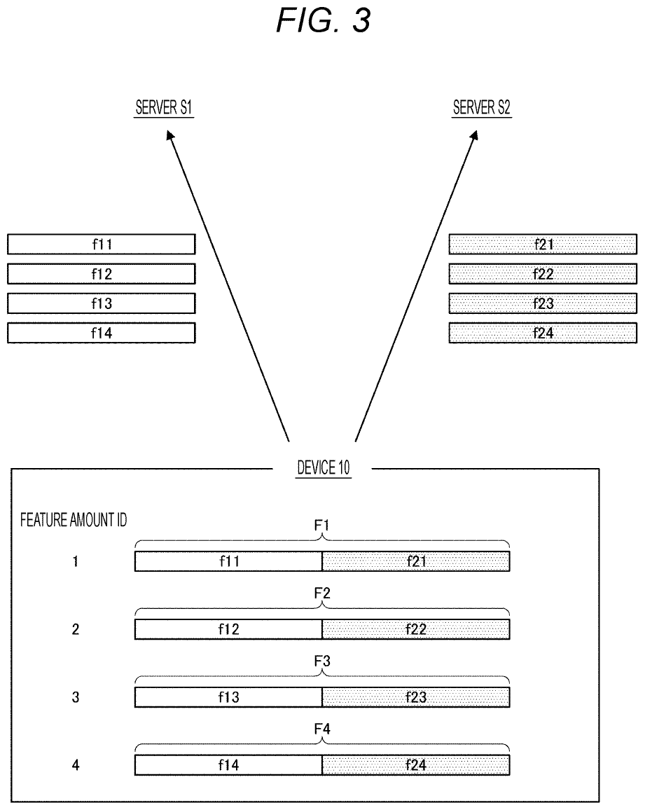

FIG. 3 is an explanatory diagram for explaining an example of generation and transmission of partial feature amounts to the server S by the device 10. Here, an example in which the device 10 generates a first partial feature amount f1n and a second partial feature amount f2n (n is a natural number corresponding to a feature amount ID as described later) from four feature amounts F will be described, but the number of feature amounts to be handled is not limited thereto. Note that, hereinafter, the first partial feature amount f1n and the second partial feature amount f2n may be simply referred to as a first partial feature amount f1 and a second partial feature amount f2.

The device 10 generates a first partial feature amount f1 and a second partial feature amount f2 for each of a feature amount F1 with the feature amount ID of 1 for identifying a feature amount F, a feature amount F2 with the feature amount ID of 2, a feature amount F3 with the feature amount ID of 3, and a feature amount F4 with the feature amount ID of 4. For example, the device 10 generates a first partial feature amount f11 and a second partial feature amount f21 for the feature amount F1.

Then, the device 10 transmits the first partial feature amounts f11 to f14 to the server S1. In addition, the device 10 transmits second partial feature amounts f21 to f24 to the server S2. Note that the plurality of partial feature amounts generated from the plurality of different feature amounts F may be simultaneously transmitted to the server S, or may be transmitted to the server S at different timings. Each of the plurality of partial feature amounts may be transmitted to the server S one by one, for example, each time YES is determined in S103 of the flow illustrated in FIG. 2. In addition, the server S may store and hold the received partial feature amount.

### <<2. Functional Configuration Example of Server S According to Present Embodiment>>

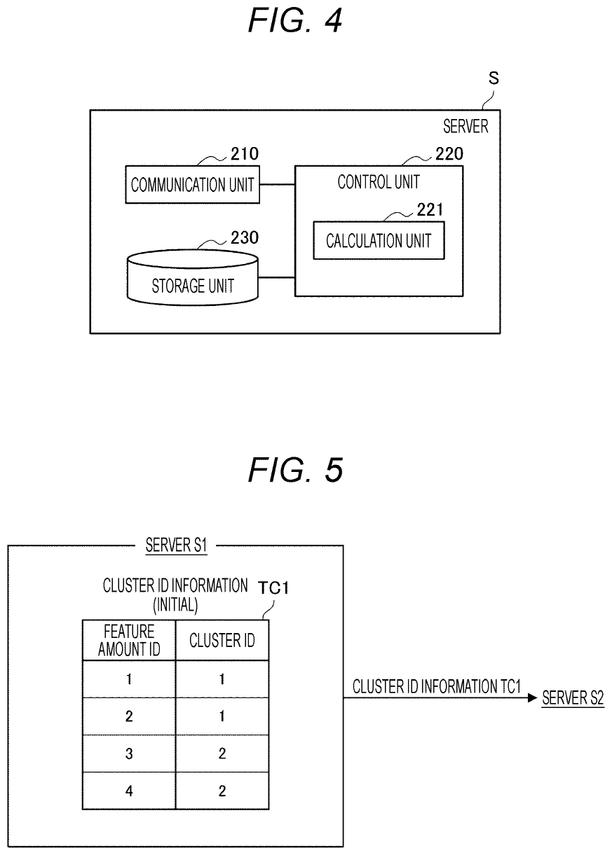

Next, a configuration of the server S will be described with reference to FIG. 4. FIG. 4 is a block diagram illustrating an example of a configuration of the server S according to the present embodiment. As illustrated in FIG. 4, the server S includes a communication unit 210, a control unit 220, and a storage unit 230.

### (Communication Unit 210)

The communication unit 210 is connected to an external device via the network 30 and transmits and receives data. For example, the communication unit 210 transmits and receives data to and from the device 10 and another server S. The communication unit 210 can be communicably connected to a terminal or the like by, for example, a wired or wireless local area network (LAN), Wi-Fi (registered trademark), Bluetooth (registered trademark), or the like.

The communication unit 210 acquires the partial feature amount from the device 10, for example. Furthermore, the communication unit 210 transmits information indicating the center point for each cluster of partial feature amounts to the device 10. The center point of each cluster of partial feature amounts is used when the device 10 updates the user feature amount. A method of calculating the center point for each cluster of partial feature amounts will be described later in detail.

### (Control Unit 220)

The control unit 220 functions as an arithmetic processing device and a control device, and controls the overall operation in the server S according to various programs. The control unit 220 according to the present embodiment also functions as a calculation unit 221.

### (Calculation Unit 221)

The calculation unit 221 calculates a value representing a relationship with a reference point for determining the user feature amount for each of the plurality of partial feature amounts acquired by the communication unit 210. Here, the reference point in the server S1 is referred to as a first reference point. In addition, a value representing the relationship between the partial feature amount and the first reference point in the server S1 is referred to as a first value. In addition, a reference point in the server S2 is referred to as a second reference point, and a value representing a relationship between a partial feature amount and the second reference point is referred to as a second value. The value representing the relationship between the partial feature amount and the reference point calculated by the other server S is acquired by the communication unit 210.

The value representing the relationship between the partial feature amount and the reference point in the present embodiment is a Euclidean distance between the partial feature amount and the reference point. However, the value representing the relationship with the reference point is not particularly limited as long as the value represents the degree of similarity between the partial feature amount and the reference point. For example, the value representing the relationship between the partial feature amount and the reference point may be an inner product, a correlation, or a cosine distance. For example, in a case where the value representing the relationship between the partial feature amount and the reference point is a correlation value, the larger the value, the more similar the partial feature amount and the reference point are. Note that, in the present specification and the drawings, the Euclidean distance may be simply referred to as a “distance”.

The reference point is different depending on a clustering method used at the time of clustering. For example, in a case where the k-means algorithm is used as the clustering method, the reference point is a center point of a cluster of partial feature amounts calculated for each server S. Furthermore, in a case where the hierarchical clustering algorithm is used as the clustering method, the reference point is each of the other partial feature amounts acquired by the same server S. The calculation of the value representing the relationship with the reference point in each clustering method will be described later in detail using an operation example.

The value representing the relationship with the reference point calculated by one server S is transmitted to the other server S. In the present embodiment, the second value calculated by the calculation unit 221 of the server S2 is acquired by the communication unit 210 of the server S1.

The calculation unit 221 calculates an integrated value obtained by integrating the first value and the second value. The integrated value is calculated by one of the plurality of servers S. In the present embodiment, an example in which the integrated value is calculated by the server S1 will be described. More specifically, the calculation unit 221 of the server S1 calculates an integrated value obtained by integrating the first value and the second value. In the present embodiment, the integrated value is referred to as an integration distance. In the present embodiment, the integration distance is calculated by adding the first value and the second value that are Euclidean distances. Then, the calculation unit 221 calculates a center point for each cluster of partial feature amounts for determining the user feature amounts, using the calculated integration distance.

### (Storage Unit 230)

The storage unit 230 is realized by a ROM that stores programs, operation parameters, and the like used for processing of the control unit 220, and a RAM that temporarily stores parameters and the like that change as appropriate.

For example, the storage unit 230 may store the partial feature amount acquired from the feature amount indicating the registered user for each user. The storage unit 230 may store a partial feature amount newly acquired from the device 10 at the time of processing each time processing for determining the user feature amount is performed.

Furthermore, the storage unit 230 may delete a partial feature amount for which a certain period has elapsed from acquisition. As a result, the user feature amount is calculated using only the partial feature amount acquired within the certain period. If the user feature amount is determined without deleting the partial feature amount for which a certain period has elapsed from the acquisition, it is conceivable that a person who is not the user is determined to be the user when the user is determined by the device 10. This is because the user's face changes with the passage of time. That is, by deleting the partial feature amount for which a certain period of time has elapsed from the acquisition, it is possible to cope with the change of the user's face with the passage of time.

### <<3. Operation Example According to Present Embodiment>>

Next, an operation example according to the present embodiment will be described. In each operation example, processing for determining the user feature amount using the partial feature amount performed by the server S1 and the server S2 will be described.

### <3-1. First Operation Example>

First, a first operation example will be described. In the first operation example, processing of determining the user feature amount on the basis of the k-means algorithm will be described with reference to FIGS. 5 to 10.

### (Initialization)

In the first operation example, first, as described with reference to FIG. 3, the first partial feature amount f1 is transmitted from the device 10 to the server S1. In addition, the second partial feature amount f2 is transmitted from the device 10 to the server S2. Subsequently, the calculation unit 221 of the server S1 temporarily allocates a predetermined number (for example, K) of cluster IDs to each feature amount F at random. A cluster to which each feature amount temporarily belongs is referred to as a provisional cluster C.

FIG. 5 is an explanatory diagram for explaining an example in which a cluster ID is temporarily allocated by the server S1 according to the first operation example. As illustrated in FIG. 5, the server S1 generates initial cluster ID information TC1 that is a result of allocating a cluster ID to each feature amount F. FIG. 5 illustrates an example in which a cluster ID is allocated to each feature amount F so that two cluster IDs 1 and 2 are associated with each feature amount ID (that is, these are put into the provisional cluster C).

Then, the communication unit 210 of the server S1 transmits the cluster ID information TC1 generated by the calculation unit 221 to the server S2.

### (Generation of Distance Table)

Subsequently, each of the calculation units 221 of the server S1 and the server S2 calculates the center point of the partial feature amount of the feature amount F belonging to each provisional cluster C as the center point of the provisional cluster C for the partial feature amount. Hereinafter, the center point of the provisional cluster C for the first partial feature amount f1 is referred to as a “first center point”. The first center point is a first reference point in the present operation example. Further, hereinafter, the center point of the provisional cluster C for the second partial feature amount is referred to as a “second center point”. The second center point is a second reference point in the present operation example.

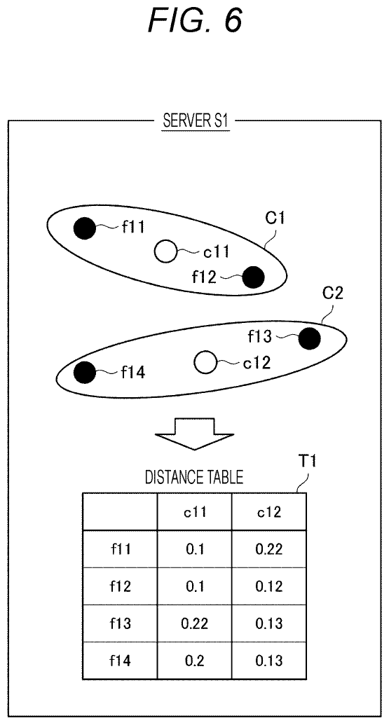

Subsequently, the calculation unit 221 of the server S1 calculates the distance between the first partial feature amount f1 and a first center point c1n. Here, n is a natural number corresponding to the cluster ID of the provisional cluster C. Note that the first center point c1n may be simply referred to as a “first center point c1”. FIG. 6 is an explanatory diagram for explaining an example in which the calculation unit 221 of the server S1 calculates the distance between the first partial feature amount f1 and the first center point c1.

In FIG. 6, the calculation unit 221 of the server S1 calculates a first center point c11 which is a center point between the first partial feature amount f11 corresponding to the feature amount F1 belonging to the provisional cluster C1 having the cluster ID of 1 and the first partial feature amount f12 corresponding to the feature amount F2. In addition, the calculation unit 221 of the server S1 calculates a first center point c12 which is a center point between the first partial feature amount f13 corresponding to the feature amount F3 belonging to the provisional cluster C2 having the cluster ID of 2 and the first partial feature amount f14 corresponding to the feature amount F4.

Then, the calculation unit 221 of the server S1 calculates a distance (first value in the first operation example) between each first partial feature amount f1 and each first center point c1. A distance table T1 stores the calculation result of the distance between each first partial feature amount f1 and each first center point c1 generated by the calculation unit 221 of the server S1. For example, the calculation unit 221 of the server S1 calculates the distance between the first partial feature amount f11 and the first center point c11 as “0.1”, and stores the distance in the distance table T1.

Subsequently, the calculation unit 221 of the server S2 calculates the distance (second value in the first operation example) between the second partial feature amount f2 and the second center point c2 by a method similar to the method of calculating the distance between the first partial feature amount f1 and the first center point c1 by the server S1.

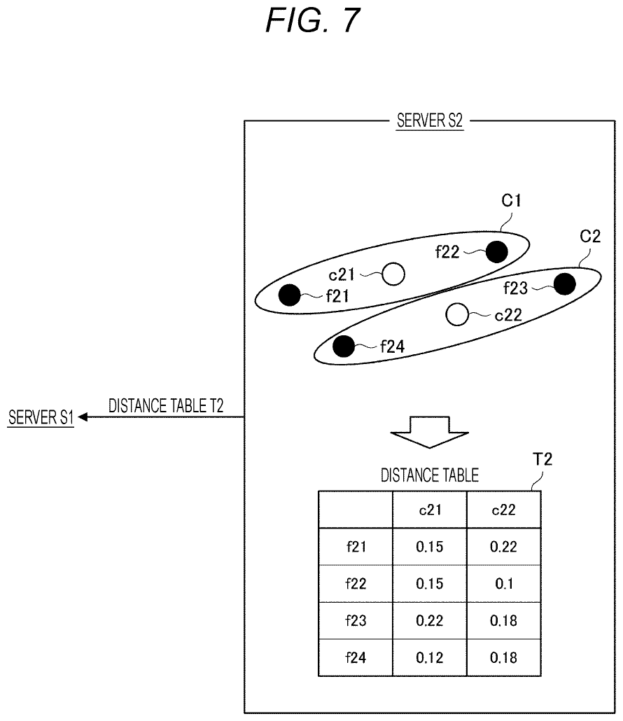

FIG. 7 is an explanatory diagram for explaining an example in which the calculation unit 221 of the server S2 calculates the distance between the second partial feature amount f2 and a second center point c2n. Here, n is a natural number corresponding to the cluster ID of the provisional cluster C. Note that, hereinafter, the second center point c2n may be simply referred to as a “second center point c2”. In FIG. 7, the calculation unit 221 of the server S2 calculates a second center point c21 which is a center point between the second partial feature amount f21 corresponding to the feature amount F1 and the second partial feature amount f22 corresponding to the feature amount F2 which belong to the provisional cluster C1 having the cluster ID of 1. In addition, the calculation unit 221 of the server S2 calculates a second center point c22 which is a center point of the second partial feature amount f23 corresponding to the feature amount F3 and the second partial feature amount f24 corresponding to the feature amount F4 which belong to the provisional cluster C2 having the cluster ID of 2.

Then, the calculation unit 221 of the server S2 calculates the distance between each second partial feature amount f2 and each second center point c2. A distance table T2 stores the calculation result of the distance between each second partial feature amount f2 and each second center point c2 generated by the calculation unit 221 of the server S2. For example, the calculation unit 221 of the server S2 calculates the distance between the second partial feature amount f21 and the second center point c21 as “0.15”, and stores the distance in the distance table T2.

The communication unit 210 of the server S2 transmits the generated distance table T2 to the server S1.

### (Reallocation of Provisional Cluster to Feature Amount)

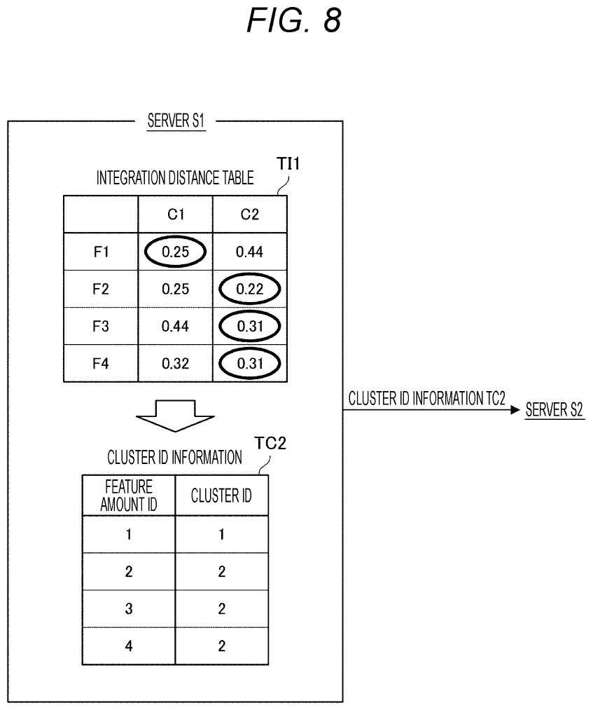

Subsequently, the calculation unit 221 of the server S1 calculates the integration distance on the basis of the generated distance table T1 and the distance table T2 received from the server S2 by the communication unit 210. Then, the calculation unit 221 of the server S1 allocates the provisional cluster C to each feature amount F on the basis of the calculated integration distance. FIG. 8 is an explanatory diagram for explaining an example in which the calculation unit 221 of the server S1 calculates the integration distance and allocates the provisional cluster C to the feature amount F.

For each feature amount F, the calculation unit 221 of the server S1 integrates distances between a center point of the same provisional cluster C and partial feature amounts based on the same feature amount F to calculate an integration distance. For example, the calculation unit 221 of the server S1 integrates the feature amount F1 by adding a distance between the first center point c11 and the first partial feature amount f11 for the provisional cluster C1 and a distance between the second center point c21 and the second partial feature amount f21 for the provisional cluster C1. More specifically, the calculation unit 221 of the server S1 calculates “0.25” by adding the distance “0.1” between the first center point c11 and the first partial feature amount f11 and the distance “0.15” between the second center point c21 and the second partial feature amount f21. The calculation unit 221 of the server S1 generates an integration distance table TI1 indicating the calculation result of the integration distance for each provisional cluster C for each feature amount F.

The integration distance calculated here represents a similarity relationship between each feature amount F and each provisional cluster C. More specifically, the shorter the integration distance, the more similar the relationship between the feature amount F and the provisional cluster C. Therefore, the calculation unit 221 of the server S1 puts each of the feature amounts F into the most similar provisional cluster C among the plurality of provisional clusters C, that is, the provisional cluster C having the shortest integration distance. For example, since the integration distance of the provisional cluster C1 is the shortest for the feature amount F1, the calculation unit 221 of the server S1 puts the feature amount F1 into the provisional cluster C1. The calculation unit 221 of the server S1 allocates the provisional cluster C to all the feature amounts F, and generates cluster ID information TC2 indicating the allocation.

### (Determination of Cluster of Feature Amounts)

Subsequently, the communication unit 210 of the server S1 transmits the generated cluster ID information TC2 to the server S2. Then, the server S1 and the server S2 repeat the allocation of the provisional cluster C using the integration distance described with reference to FIGS. 6 to 8. In a case where the provisional cluster C to which each feature amount F belongs is the same as the provisional cluster C to which each feature amount F immediately before belongs, the calculation unit 221 of the server S1 determines the provisional cluster C as a cluster to which each feature amount F belongs. Alternatively, the calculation unit 221 of the server S1 may determine the provisional cluster C as a cluster to which each feature amount F belongs in a case where the allocation of the provisional cluster C to the feature amount F is repeated a predetermined number of times.

### (Determination of User Feature Amount)

Subsequently, the calculation unit 221 of the server S1 calculates the first center point c1 of the first partial feature amount f1 for each determined cluster. The communication unit 210 of the server S1 transmits the calculated first center point c1 to the device 10 in association with the cluster ID. In addition, the calculation unit 221 of the server S2 calculates the second center point c2 of the second partial feature amount f2 for each determined cluster. The communication unit 210 of the server S2 transmits the calculated second center point c2 to the device 10 in association with the cluster ID. The device 10 determines the user feature amount for each cluster on the basis of the received first center point c1 and second center point c2.

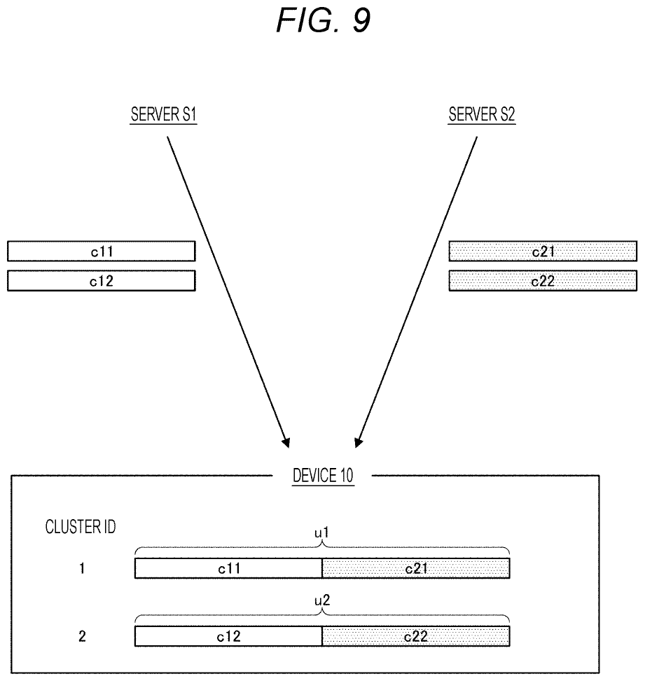

FIG. 9 is an explanatory diagram for explaining an example in which the device 10 determines the user feature amount for each cluster. The communication unit 210 of the server S1 transmits the determined first center point c1 for each cluster to the device 10. The communication unit 210 of the server S2 transmits the determined second center point c2 for each cluster to the device 10. The device 10 determines a user feature amount u by combining the first center point c1 and the second center point c2 for each cluster. For example, the device 10 combines the first center point c11 and the second center point c21 of the cluster having the cluster ID of 1 to determine a user feature amount u1.

Here, the device 10 determines the user feature amount u such that the dimension in the feature amount of each of the feature amount components of the partial feature amount and the dimension in the user feature amount u of each of the feature amount components of the center point coincide with each other. For example, a case where the first partial feature amount f1 includes 1 to N/2-dimensional feature amount components of the feature amount F, and the second partial feature amount f2 includes N/2+1 to N-dimensional feature amount components of the feature amount F will be described. The device 10 determines the user feature amount u such that the 1 to N/2-dimensional feature amount components of the user feature amount u coincide with the 1 to N/2-dimensional feature amount components of the first center point c1 including the N/2-dimensional feature amount components. Further, the device 10 determines the user feature amount u such that the N/2-dimensional to N-dimensional feature amount components of the user feature amount u coincide with the 1-dimensional to N/2-dimensional feature amount components of the second center point c2 including the N/2-dimensional feature amount components.

According to the first operation example described above, it is possible to calculate the user feature amount with accuracy equivalent to the method in which one server receives the feature amount of the face image from the device 10 and calculates the user feature amount described above as a comparative example. In addition, the calculation amount of the server S according to the first operation example is substantially the same as the calculation amount of the server according to the comparative example, and the user feature amount can be calculated without increasing the processing load. Furthermore, according to the first operation example, if a plurality of servers having performance equivalent to that of the server according to the comparative example is prepared, the user feature amount can be calculated without preparing a special device.

In addition, according to the first operation example, the information transmitted and received between the server S and the device 10 is only the partial feature amount and the information of the first center point or the second center point. An individual cannot be specified only by the partial feature amount and the information of the first center point or the second center point. Further, the information transmitted and received between the servers S is only the information on the value representing the relationship with the reference point, the feature amount ID, and the cluster ID. That is, communication between the servers S does not include information for identifying an individual. That is, according to the first operation example, the server S can realize protection of personal information of the user.

### (Flow of First Operation Example)

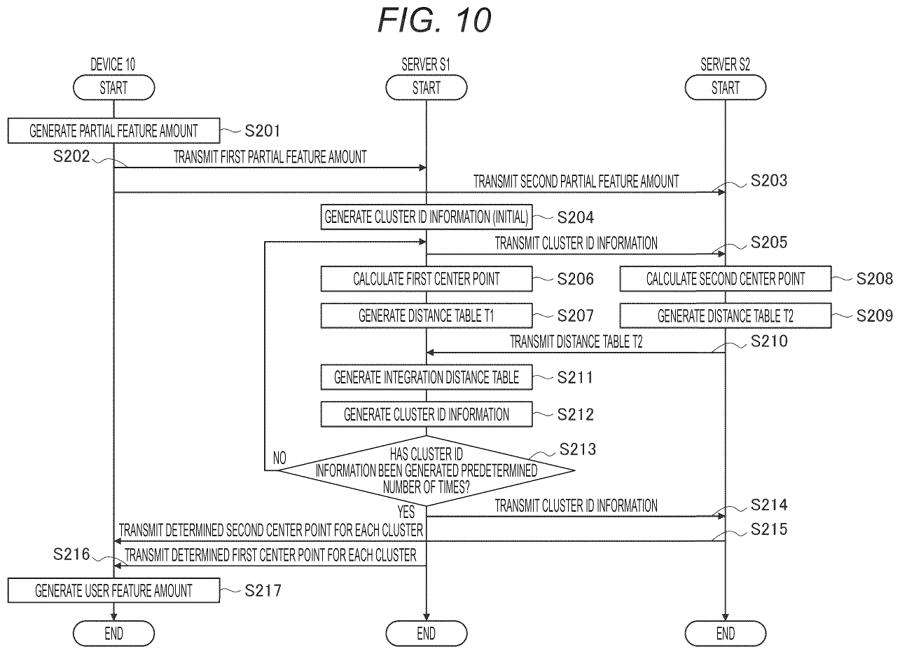

The flow of the first operation example described above will be described with reference to the sequence diagram of FIG. 10. FIG. 10 is a sequence diagram illustrating an example of a flow of the first operation example according to the present embodiment. The sequence diagram of FIG. 10 can be applied as a processing flow of a subroutine of S104 in the flow diagram illustrated in FIG. 2.

First, the device 10 generates the first partial feature amount and the second partial feature amount from the feature amounts (S201). Subsequently, the device 10 transmits the generated first partial feature amount to the server S1 (S202). Further, the device 10 transmits the generated second partial feature amount to the server S2 (S203).

The calculation unit 221 of the server S1 allocates a provisional cluster to each feature amount at random. Then, the calculation unit 221 of the server S1 generates cluster ID information indicating initial allocation of each feature amount (S204). Subsequently, the communication unit 210 of the server S1 transmits the generated cluster ID information to the server S2 (S205).

Subsequently, the calculation unit 221 of the server S1 calculates a first center point of each provisional cluster (S206). Then, the calculation unit 221 of the server S1 generates the distance table T1 which is a calculation result of the distance between each first partial feature amount and each first center point (S207).

In addition, the calculation unit 221 of the server S2 calculates a second center point of each provisional cluster (S208). Then, the calculation unit 221 of the server S2 generates the distance table T2 which is a calculation result of the distance between each second partial feature amount and each second center point (S209). The communication unit 210 of the server S2 transmits the generated distance table T2 to the server S1 (S210).

The calculation unit 221 of the server S1 generates an integration distance table on the basis of the distance table T1 and the distance table T2 (S211). Subsequently, the calculation unit 221 of the server S1 puts each of the feature amounts into a provisional cluster having the shortest integration distance among the plurality of provisional clusters. Then, the calculation unit 221 of the server S1 generates cluster ID information indicating allocation of a provisional cluster to each feature amount (S212).

Here, the control unit 220 of the server S1 determines whether or not the calculation unit 221 has generated the cluster ID information a predetermined number of times (S213). In a case where the calculation unit 221 does not generate the cluster ID information the predetermined number of times (S213/NO), the control unit 220 returns the processing to S205, and repeats the processing in S205 to S212 until the calculation unit 221 generates the cluster ID information the predetermined number of times.

In a case where the calculation unit 221 of the server S1 generates the cluster ID information the predetermined number of times (S213/YES), the communication unit 210 of the server S1 transmits the cluster ID information indicating the allocation of the determined cluster to each feature amount to the server S2 (S214).

The calculation unit 221 of the server S2 calculates the second center point of the second partial feature amount for each determined cluster on the basis of the received cluster ID information. Then, the communication unit 210 of the server S2 transmits the calculated second center point to the device 10 (S215).

The calculation unit 221 of the server S1 calculates the first center point of the first partial feature amount for each determined cluster on the basis of the generated cluster ID information. Then, the communication unit 210 of the server S1 transmits the calculated first center point to the device 10 (S216).

The device 10 determines the user feature amount for each cluster by combining the received first center point and second center point (S217).

### <3-2. Second Operation Example>

The first operation example according to the present embodiment has been described above. Next, a second operation example according to the present embodiment will be described. In the second operation example, similarly to the first operation example, the user feature amount is determined on the basis of the k-means algorithm. In the first operation example, an example has been described in which the distance table is transmitted from the server S2 to the server S1 for each processing of allocation of the provisional cluster to each feature amount. In the second operation example, an example in which the distance table is transmitted from the server S2 to the server S1 only once will be described with reference to FIGS. 11 to 15.

### (Clustering of Each Partial Feature Amount)

In the second operation example, first, as described with reference to FIG. 3, the first partial feature amount f1 is transmitted from the device 10 to the server S1. In addition, the second partial feature amount f2 is transmitted from the device 10 to the server S2. Subsequently, the calculation units 221 of the server S1 and the server S2 cluster the received partial feature amounts into a predetermined number (for example, K) by the k-means algorithm, and calculate the center points of the partial feature amounts belonging to each cluster.

FIG. 11 is an explanatory diagram for explaining an example in which the server S1 and the server S2 calculate the center point of the partial feature amount belonging to the cluster. In the example illustrated in FIG. 11, the calculation unit 221 of the server S1 puts the first partial feature amounts into five clusters by the k-means algorithm. The calculation unit 221 of the server S1 calculates the center point of the first partial feature amount f1 belonging to each cluster as the first center points c11 to c15 of the cluster.

In addition, the calculation unit 221 of the server S2 puts the second partial feature amounts into five clusters by the k-means algorithm. The calculation unit 221 of the server S2 calculates the center point of the second partial feature amount f2 belonging to each cluster as the second center points c21 to c25 of the cluster.

### (Determination of Combination of First Center Point and Second Center Point)

Here, similarly to the first operation example, the device 10 determines the user feature amount by combining the first center point and the second center point. Therefore, in the second operation example, it is necessary to determine which first center point c1 and which second center point c2 are to be coupled.

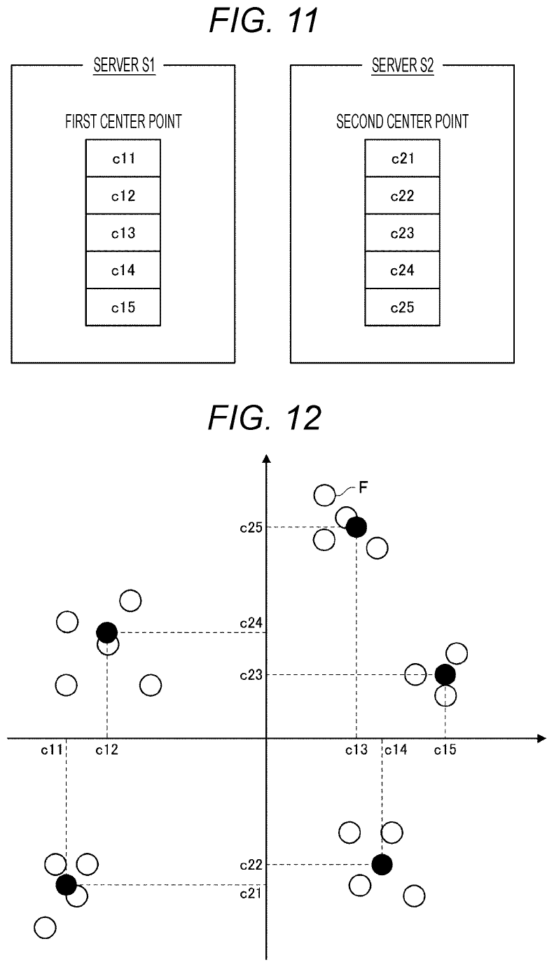

FIG. 12 is an explanatory diagram for explaining the distribution of the feature amounts F. Although FIG. 12 illustrates an example in which the feature amounts F are distributed in a two-dimensional coordinate system for easy understanding of description, the feature amount F may be configured in three or more dimensions.

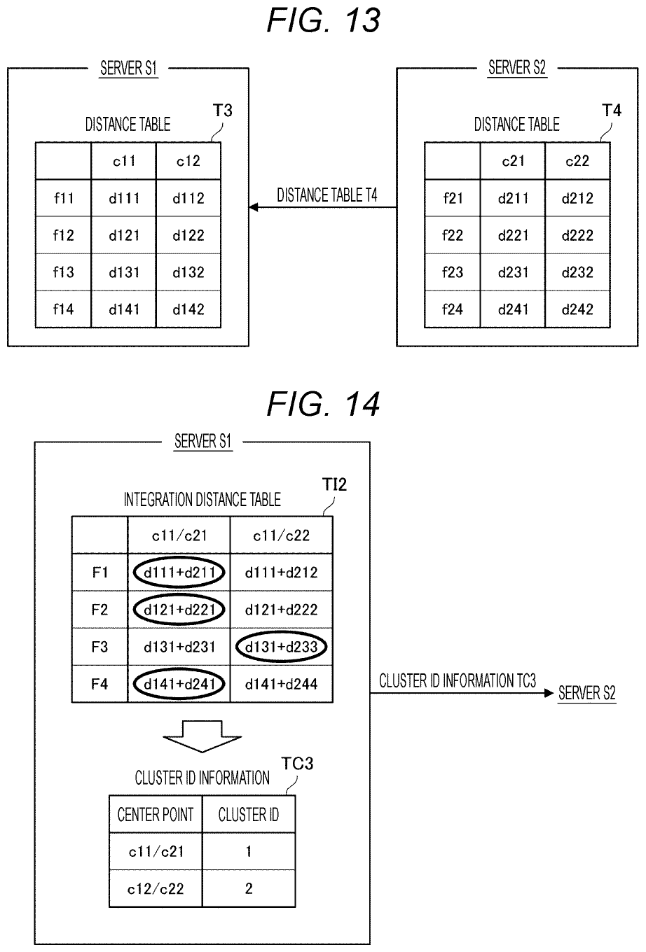

Here, it is assumed that the first center points c11 to c15 and the second center points c21 to c25 are calculated as described with reference to FIG. 11, and the calculated first center points c11 to c15 and the calculated second center points c21 to c25 are distributed as illustrated in FIG. 12. Referring to the distribution of the feature amount F indicated by a plurality of white points in FIG. 12, it is understood that each of the user feature amounts is desirably expressed as (c11, c21), (c12, c24), (c13, c25), (c14, c22), and (c15, c23). A method of determining a combination of the first center point and the second center point for determining the user feature amount in this manner will be described with reference to FIGS. 13 and 14.

The calculation unit 221 of the server S1 calculates a distance (first value in the second operation example) between each first partial feature amount f1 and each first center point c1. In addition, the calculation unit 221 of the server S2 calculates a distance (second value in the second operation example) between each second partial feature amount f2 and each second center point c2. FIG. 13 is an explanatory diagram for explaining an example in which the calculation units 221 of the server S1 and the server S2 calculate the distances between each partial feature amount and each center point. In FIG. 13, in order to simplify the description, an example in which two first center points c1 and two second center points c2 are calculated (that is, the partial feature amounts are clustered into two) will be described.

A distance table T3 stores the calculation result of the distance between each first partial feature amount f1 and each first center point c1 generated by the calculation unit 221 of the server S1. For example, the calculation unit 221 of the server S1 stores a calculated distance d111 between the first partial feature amount f11 and the first center point c11 in the distance table T3.

In addition, a distance table T4 stores a calculation result of the distance between each second partial feature amount f2 and each second center point c2 generated by the calculation unit 221 of the server S2. For example, the calculation unit 221 of the server S2 stores a calculated distance d211 between the second partial feature amount f21 and the second center point c21 in the distance table T4.

The communication unit 210 of the server S2 transmits the generated distance table T4 to the server S1.

Subsequently, the calculation unit 221 of the server S1 calculates the integration distance on the basis of the generated distance table T3 and the distance table T4 received from the server S2 by the communication unit 210. Then, the calculation unit 221 of the server S1 determines a combination of the first center point c1 and the second center point c2 for determining the user feature amount on the basis of the calculated integration distance.

FIG. 14 is an explanatory diagram for explaining an example in which the calculation unit 221 of the server S1 determines a combination of the first center point c1 and the second center point c2 for determining the user feature amount by calculating the integration distance.

First, the calculation unit 221 of the server S1 generates a combination candidate of the first center point c1 and the second center point c2. Here, when the calculation unit 221 of the server S1 determines one combination of the first center point c1 and the second center point c2 when combining the first center point c1 and the second center point c2, another combination of the first center point c1 and the second center point c2 is also determined naturally. For example, when the calculation unit 221 of the server S1 combines the first center point c11 and the second center point c21, it is determined that the first center point c12 and the second center point c22 are combined. Therefore, the calculation unit 221 of the server S1 may generate a combination candidate of the first center point c1 and the second center point c2 except for such a combination that is naturally determined.

In the example illustrated in FIG. 14, the calculation unit 221 of the server S1 generates two combinations of the first center point c11 and the second center point c21 and the first center point c11 and the second center point c22. Note that the calculation unit 221 may generate combinations of all the first center points c11 and the second center points c21 including combinations determined naturally as combination candidates.

The calculation unit 221 calculates an integration distance for each combination of the first center point c1 and the second center point c2 for each feature amount F for a combination candidate of the first center point c1 and the second center point c2. For example, the calculation unit 221 calculates an integrated value by adding the distance d111 between the first partial feature amount f11 and the first center point c11 and the distance d211 between the second partial feature amount f21 and the second center point c21 with respect to the feature amount F1 in a case where the first center point c11 and the second center point c21 are combined.

The calculation unit 221 of the server S1 generates an integration distance table TI2 indicating the calculation result of the integration distance for each combination of the first center point c1 and the second center point c2 for each feature amount F.

Here, for the same feature amount F, the shorter the corresponding integration distance, the more suitable the combination candidate for the feature amount F. This is because the shorter the integration distance, the more similar the feature amount F is to the user feature amount determined by combining the first center point c1 and the second center point c2. Therefore, the calculation unit 221 of the server S1 selects which combination candidate corresponds to a shorter integration distance for each feature amount F. Then, the calculation unit 221 of the server S1 determines the selected combination as a combination in the feature amount F. For example, in a case of d111+d211<d111+d212 in FIG. 14, the calculation unit 221 of the server S1 determines the combination of the first center point c11 and the second center point c21 as the combination in the feature amount F1.

After determining the combinations of the first center point c1 and the second center point c2 in all the feature amounts F, the calculation unit 221 of the server S1 determines the combination having the largest number determined as the combination in the feature amount F as the combination for determining the user feature amount.

In the example of FIG. 14, a combination of the first center point c11 and the second center point c21 is selected for the feature amounts F1, F2, and F4, and a combination of the first center point c11 and the second center point c22 is selected for the feature amount F3. In such a case, the calculation unit 221 of the server S1 determines a combination of the first center point c11 and the second center point c21 as a combination for determining the user feature amount.

In the examples illustrated in FIGS. 13 and 14, the determination of the combination in a case where the partial feature amounts are clustered into two has been described. Hereinafter, a method of determining a combination in a case where partial feature amounts are clustered into three or more will be described.

As an example of a method of determining a combination in a case where partial feature amounts are clustered into three or more, the calculation unit 221 of the server S1 determines which second center point c2 is combined with one first center point c1 (first center point c1 to be determined) among the plurality of first center points c1.

Specifically, first, the calculation unit 221 of the server S1 generates a combination candidate by combining the first center point c1 of the first determination target and each second center point c2. Subsequently, the calculation unit 221 of the server S1 calculates the integration distance for each feature amount F for each combination candidate by a method similar to the method described with reference to FIGS. 13 and 14. Then, the calculation unit 221 of the server S1 determines a combination of the first center point c1 and the second center point c2 of the first determination target for determining the user feature amount by determining a combination in the feature amount F on the basis of the calculated integration distance.

When the second center point c2 combined with the first center point c1 of the first determination target is determined, the second center point c2 combined with the second first center point c1 of the second determination target is subsequently determined. The second center point c2 that is a candidate for combination with the first center point c1 of the second determination target is a second center point c2 other than the second center point c2 that has already been determined to be combined with the first center point c1 of the first determination target. In this manner, by sequentially determining the second center point c2 to be combined with the first center point c1 to be determined, a combination of each first center point c1 and each second center point c2 for determining the user feature amount is determined.

Note that, in a case where three or more partial feature amounts are generated for one feature amount F by the device 10 and processing is performed by three or more servers S, the combination may be determined first by determining a combination of center points calculated by any two servers S among the plurality of servers S. Subsequently, a combination of the determined combination and a center point calculated by another server S other than the two servers S may be determined. For example, in a case where the processing is performed by the server S1, the server S2, and the server S3 which are the three servers S, first, a combination of the first center point calculated by the server S1 and the second center point calculated by the server S2 is determined by the calculation unit 221 of the server S1. Subsequently, the calculation unit 221 of the server S1 determines a combination of the determined combination of the first center point and the second center point and a center point calculated by the server S3.

The calculation unit 221 of the server S1 generates cluster ID information TC3 indicating the allocation of the cluster ID to the first center point c1 and the second center point c2 included in the determined combination. Here, the calculation unit 221 allocates different cluster IDs to the first center point c1 and the second center point c2 included in the combination of the first center point c1 and the second center point c2, which is naturally determined by determining the combination of the one first center point c1 and the second center point c2.

For example, the calculation unit 221 allocates a cluster ID “1” to the first center point c11 and the second center point c21. In addition, the calculation unit 221 allocates a cluster ID “2” to the first center point c12 and the second center point c22.

The communication unit 210 of the server S1 transmits the generated cluster ID information TC3 to the server S2.

### (Determination of User Feature Amount)

Subsequently, the communication unit 210 of the server S1 transmits the first center point c1 calculated by the calculation unit 221 to the device 10 in association with the cluster ID. Furthermore, the communication unit 210 of the server S2 transmits the second center point c2 calculated by the calculation unit 221 to the device 10 in association with the cluster ID.

Note that the information on the association between the cluster ID and the second center point c2 may be transmitted to the device 10 by the communication unit 210 of the server S1. The information on the association between the cluster ID and the second center point c2 is included in the cluster ID information TC3. In this case, the communication unit 210 of the server S1 may not transmit the generated cluster ID information TC3 to the server S2. According to such a configuration, since the number of communications between the server S1 and the server S2 can be reduced, early termination of processing can be realized.

The device 10 determines the user feature amount for each cluster on the basis of the received first center point c1 and second center point c2. Since the method of determining the user feature amount for each cluster by the device 10 is similar to the method described with reference to FIG. 9 in the first operation example, the description thereof will be omitted.

The method of determining the user feature amount by determining the combination of the first center point c1 and the second center point c2 has been described above. However, in a case where only one user feature amount is determined, the calculation unit 221 does not determine the combination of the first center point c1 and the second center point c2. In this case, the calculation units 221 of the server S1 and the server S2 put the received partial feature amounts into one cluster by the k-means algorithm. Then, the device 10 combines the center points of the partial feature amounts belonging to the cluster by the method described with reference to FIG. 9 in the first operation example, and determines one user feature amount.

Furthermore, the example in which the server S1 determines the combination of the first center point c1 and the second center point c2 for determining the user feature amount has been described above, but the determination of the combination of the first center point c1 and the second center point c2 may be performed by the device 10. In this case, the device 10 receives the distance table T3 from the server S1 and the distance table T4 from the server S2. Then, the device 10 generates the integration distance table TI2 to determine a combination of the first center point c1 and the second center point c2 for determining the user feature amount.

According to the second operation example described above, similarly to the first operation example, it is possible to calculate the user feature amount without increasing the processing load as compared with the comparative example without preparing a special device. Further, according to the second operation example, similarly to the first operation example, the server S can realize protection of personal information of the user.

Furthermore, according to the second operation example, since the exchange between the servers S is reduced as compared with the first operation example, early termination of the processing can be realized. In addition, the load on the server S can be reduced by simplifying the processing as compared with the first operation example. However, according to the first operation example, since the user feature amount can be calculated more strictly than the second operation example, it is preferable to calculate the user feature amount using the first operation example in order to improve the calculation accuracy of the user feature amount.

### (Flow of Second Operation Example)

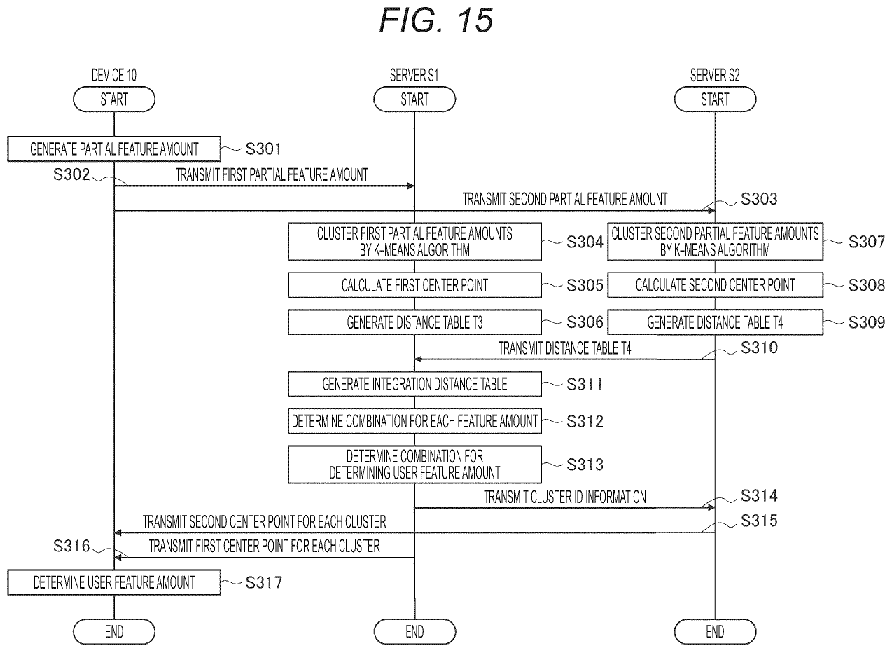

The flow of the second operation example described above will be described with reference to the sequence diagram of FIG. 15. FIG. 15 is a sequence diagram illustrating an example of a flow of the second operation example according to the present embodiment. The sequence diagram of FIG. 15 can be applied as a processing flow of a subroutine of S104 in the flow diagram illustrated in FIG. 2.

First, the device 10 generates the first partial feature amount and the second partial feature amount from the feature amounts (S301). Subsequently, the device 10 transmits the generated first partial feature amount to the server S1 (S302). Further, the device 10 transmits the generated second partial feature amount to the server S2 (S303).

Subsequently, the calculation unit 221 of the server S1 clusters the first partial feature amounts by the k-means algorithm (S304). Subsequently, the calculation unit 221 of the server S1 calculates the first center point of each cluster (S305). The calculation unit 221 of the server S1 calculates a distance between each first partial feature amount and the calculated first center point, and generates the distance table T3 storing the calculation result (S306).

On the other hand, the calculation unit 221 of the server S2 clusters the second partial feature amounts by the k-means algorithm (S307). Subsequently, the calculation unit 221 of the server S2 calculates the second center point of each cluster (S308). The calculation unit 221 of the server S2 calculates a distance between each second partial feature amount and the calculated second center point, and generates the distance table T4 storing the calculation result (S309). The communication unit 210 of the server S2 transmits the generated distance table T4 to the server S1 (S310).

Subsequently, the calculation unit 221 of the server S1 calculates the integration distance on the basis of the generated distance table T3 and the distance table T4 received from the server S2 by the communication unit 210 (S311). Then, the calculation unit 221 of the server S1 generates a combination candidate of the first center point and the second center point. The calculation unit 221 of the server S1 determines a combination for each feature amount depending on which combination candidate corresponds to a shorter integration distance for each feature amount (S312).

The calculation unit 221 of the server S1 determines, as a combination for determining the user feature amount, a combination determined most as a combination for the feature amount among the combination candidates (S313). The calculation unit 221 of the server S1 generates cluster ID information indicating the allocation of the cluster ID to the first center point and the second center point included in the determined combination. The communication unit 210 of the server S1 transmits the cluster ID information to the server S2 (S314).

Subsequently, the communication unit 210 of the server S2 transmits the second center point calculated by the calculation unit 221 to the device 10 in association with the cluster ID (S315). The communication unit 210 of the server S1 transmits the first center point calculated by the calculation unit 221 to the device 10 in association with the cluster ID (S316).

The device 10 determines the user feature amount for each cluster by combining the received first center point and second center point (S317).

### <3-3. Third Operation Example>

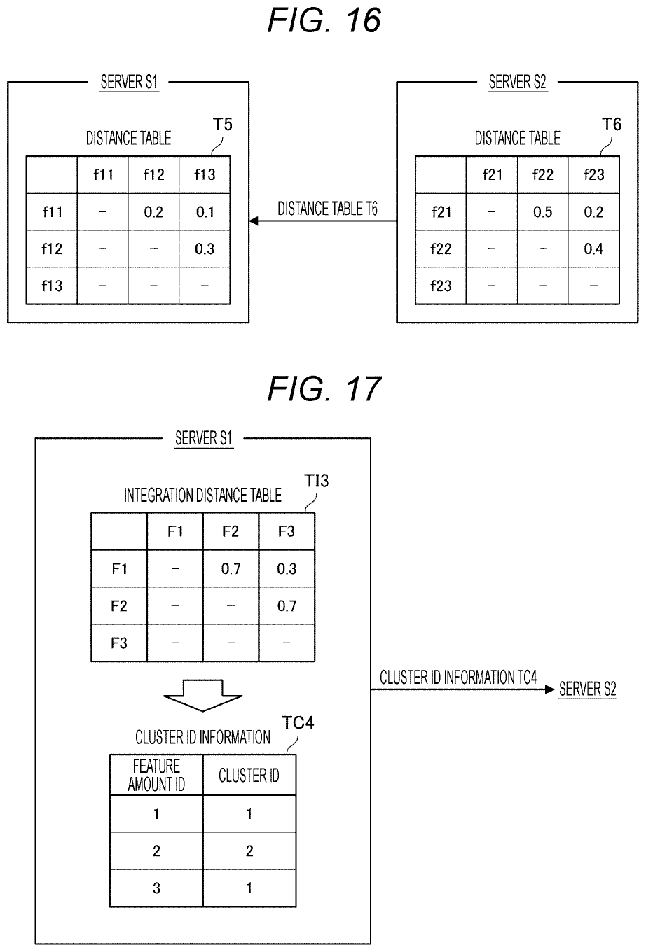

The second operation example according to the present embodiment has been described above. Next, a third operation example according to the present embodiment will be described. In the third operation example, the user feature amount is determined on the basis of the hierarchical clustering algorithm. The third operation example will be described with reference to FIGS. 16 to 19.

### (Calculation of Distance Table)

In the third operation example, first, as described with reference to FIG. 3, the first partial feature amount f1 is transmitted from the device 10 to the server S1. In addition, the second partial feature amount f2 is transmitted from the device 10 to the server S2.

Subsequently, each of the calculation units 221 of the server S1 and the server S2 calculates a distance between each partial feature amount and another partial feature amount. FIG. 16 is an explanatory diagram for explaining an example in which each of the calculation units 221 of the server S1 and the server S2 calculates a distance between each partial feature amount and another partial feature amount. FIG. 16 illustrates an example in which a first partial feature amount f1 and a second partial feature amount f2 are calculated from three feature amounts F, respectively.

The calculation unit 221 of the server S1 calculates the distance for each combination of the first partial feature amount f1 with the other first partial feature amounts f1. For example, in the example illustrated in FIG. 16, the calculation unit 221 of the server S1 calculates a distance “0.2” from the first partial feature amount f11 with respect to the first partial feature amount f12. The calculation unit 221 of the server S1 generates a distance table T5 storing each of the calculated distances. Note that the other first partial feature amount f1 is a first reference point in the present operation example. In addition, the distance between the first partial feature amount f1 and the other first partial feature amount f1 is a first value in the present operation example.

In addition, the calculation unit 221 of the server S2 calculates the distance for each combination of the second partial feature amount f2 with another second partial feature amount f2. For example, in the example illustrated in FIG. 16, the calculation unit 221 of the server S2 calculates a distance “0.5” from the second partial feature amount f21 with respect to the second partial feature amount f22. The calculation unit 221 of the server S2 generates a distance table T6 storing each of the calculated distances. Note that the other second partial feature amount f2 is a second reference point in the present operation example. In addition, the distance between the second partial feature amount f2 and the other second partial feature amount f2 is a second value in the present operation example.

The communication unit 210 of the server S2 transmits the generated distance table T6 to the server S1.

### (Cluster Allocation to Feature Amount)

Subsequently, the calculation unit 221 of the server S1 calculates the integration distance on the basis of the generated distance table T5 and the distance table T6 received from the server S2 by the communication unit 210. Then, the calculation unit 221 of the server S1 allocates a cluster to each feature amount F on the basis of the calculated integration distance. FIG. 17 is an explanatory diagram for explaining an example in which the calculation unit 221 of the server S1 calculates an integration distance and allocates a cluster to each feature amount F.

The calculation unit 221 of the server S1 calculates the integration distance by adding the distance calculated on the basis of the two first partial feature amounts and the distance calculated on the basis of the two second partial feature amounts which have the same base two feature amounts. For example, the calculation unit 221 of the server S1 integrates the distance between the first partial feature amount f11 and the first partial feature amount f12 whose base feature amounts are the feature amounts F1 and F2, and the distance between the second partial feature amount f21 and the second partial feature amount f22. That is, the calculation unit 221 of the server S1 adds “0.2” stored in the distance table T5 and “0.5” stored in the distance table T6 to integrate them, and calculates the integration distance “0.7”. The calculation unit 221 of the server S1 generates the integration distance table TI3 storing the calculation result of the integration distance for the combination of the two feature amounts F.

Then, the calculation unit 221 of the server S1 determines whether or not to put the two feature amounts F into the same cluster on the basis of the magnitude of the integration distance. For example, the calculation unit 221 of the server S1 puts the two feature amounts F included in the combination of the two feature amounts F having the smallest integration distance into the same cluster. For example, in the example illustrated in FIG. 17, since the integration distance between the feature amount F1 and the feature amount F3 is the smallest, the feature amount F1 and the feature amount F3 are put into the same cluster.

In this manner, the calculation unit 221 of the server S1 determines cluster allocation for each feature amount F by sequentially determining whether or not to put the two feature amounts F into the same cluster on the basis of the integration distance. The calculation unit 221 of the server S1 generates cluster ID information TC4 indicating the allocation. The communication unit 210 of the server S1 transmits the generated cluster ID information TC4 to the server S2.

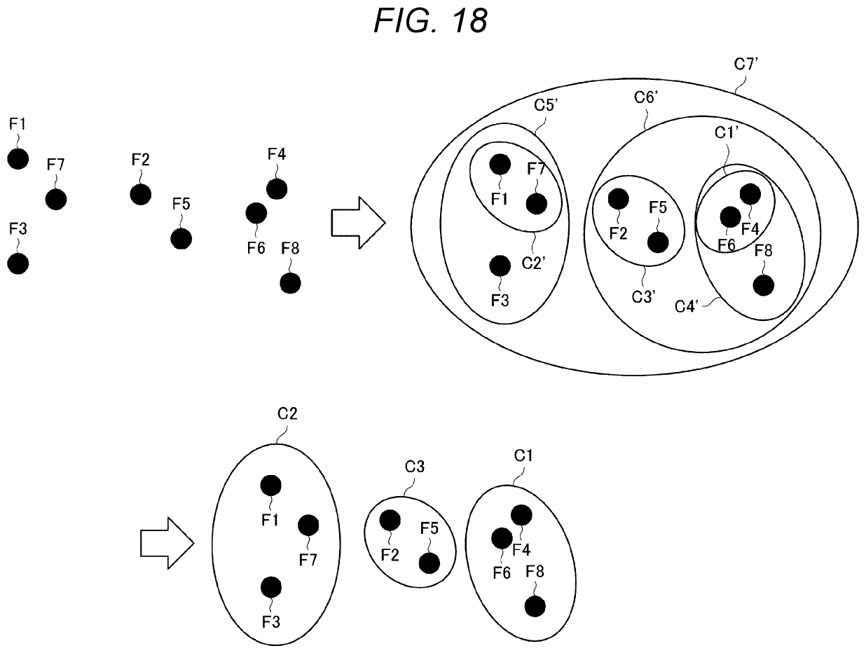

Here, a method of determining cluster allocation of each feature amount F by the calculation unit 221 of the server S1 will be described in detail with reference to FIG. 18. FIG. 18 is an explanatory diagram for explaining a method of determining cluster allocation of each feature amount F. The upper left diagram of FIG. 18 illustrates an example in which eight feature amounts F1 to F8 are distributed. The distance between the feature amounts F in FIG. 18 represents an integration distance between the feature amounts F. First, the calculation unit 221 of the server S1 puts the two feature amounts F included in the combination of the two feature amounts F having the shortest integration distance into the same cluster. In FIG. 18, since the integration distance of the feature amount F4 and the feature amount F6 is the shortest, the feature amount F4 and the feature amount F6 are put into the same cluster C1′.

Subsequently, the calculation unit 221 of the server S1 calculates the feature amount F or the distance of the center point of the cluster included in the combination for each combination of the two feature amounts F not belonging to the cluster, the feature amount F not belonging to the cluster and the center point of the cluster, and the center points of the two clusters.

Here, the calculated distance is calculated on the basis of the distances stored in the distance table T5 generated by the calculation unit 221 of the server S1 and the distance table T6 received by the communication unit 210 of the server S1 from the server S2. For example, the distance between the two feature amounts F not belonging to the cluster is a distance generated on the basis of the distance table T5 and the distance table T6 and stored in the integration distance table TI3.

In addition, the distance between the feature amount F and the center point of the cluster is calculated by averaging the integration distances between the feature amount F and each feature amount F included in the cluster. For example, the distance between the center point of the cluster C1′ and the feature amount F8 is calculated by averaging the integration distance between the feature amount F4 and the feature amount F8 and the integration distance between the feature amount F6 and the feature amount F8.

In addition, the distance between the center points of the clusters is calculated by averaging the integration distances of the respective feature amounts F included in one cluster and the respective feature amounts F included in the other cluster for each combination. For example, the distance between the center point of the cluster C1′ and the center point of the cluster C3′ is calculated by averaging the integration distance between the feature amount F4 and the feature amount F2, the integration distance between the feature amount F4 and the feature amount F5, the integration distance between the feature amount F6 and the feature amount F2, and the integration distance between the feature amount F6 and the feature amount F5.

The feature amounts F having the shortest distance calculated in this manner, the feature amount F and all the feature amounts F included in the cluster, or all the feature amounts F included in the two clusters are put into the same cluster.

The calculation unit 221 of the server S1 repeats the cluster allocation to the feature amount F on the basis of the calculated distance until a cluster to which all the feature amount F belongs is generated. The upper right part of FIG. 18 illustrates an example in which the allocation of the clusters C1′ to C7′ to the feature amounts F1 to F8 is repeated until the cluster C7′ to which all the feature amounts F belong is generated.

Here, the calculation unit 221 of the server S1 determines the final cluster allocation on the basis of the relationship between the distance between the center points of the clusters and a predetermined threshold value calculated so far. More specifically, in a case where the distance between the center points of the clusters C1′ to C6′ calculated so far is less than the predetermined threshold value, the calculation unit 221 of the server S1 combines the two clusters having the center points for which the distance less than the predetermined threshold value is calculated into one cluster. The lower part of FIG. 18 illustrates an example in which the clusters C1 to C3, which are final clusters, are allocated on the basis of the relationship between the distance between the center points of the clusters and the predetermined threshold value.

### (Determination of User Feature Amount)

When the allocation of the clusters to each feature amount F is determined by the method described above, each of the calculation units 221 of the server S1 and the server S2 calculates the center point of the partial feature amount belonging to each cluster. Specifically, the server S1 calculates the first center point of each cluster. In addition, the server S2 calculates the second center point of each cluster.

Then, the communication unit 210 of the server S1 transmits the first center point calculated by the calculation unit 221 to the device 10 in association with the cluster ID. Furthermore, the communication unit 210 of the server S2 transmits the second center point calculated by the calculation unit 221 to the device 10 in association with the cluster ID.

The device 10 determines the user feature amount for each cluster on the basis of the received first center point c1 and second center point c2. Since the method of determining the user feature amount for each cluster by the device 10 is similar to the method described with reference to FIG. 9 in the first operation example, the description thereof will be omitted.

According to the third operation example described above, similarly to the first operation example, the server S can calculate the user feature amount without increasing the processing load as compared with the above-described comparative example without preparing a special device. Furthermore, according to the third operation example, the server S can realize protection of personal information of the user, similarly to the first operation example.

Furthermore, according to the third operation example, the user feature amount can be calculated with the same accuracy as the method of calculating the user feature amount in the above-described comparative example. In addition, according to such an operation example, the exchange between the servers is only required to transmit the distance table T6 from the server S2 to the server S1 and transmit the cluster ID information TC4 from the server S1 to the server S2, and thus, it is also possible to realize early termination of the processing. Therefore, according to the third operation example, it is possible to accurately calculate the user feature amount at an early stage and protect the personal information of the user.

Note that, although the example in which the server S1 determines the cluster allocation to the feature amount F for determining the user feature amount has been described above, the cluster allocation to the feature amount F may be performed by the device 10. In this case, the device 10 receives the distance table T5 from the server S1 and the distance table T6 from the server S2. Then, the device 10 generates the integration distance table TI3 to determine cluster allocation to the feature amount F for determining the user feature amount.

According to such a configuration, the creation of the distance table requiring a high calculation cost is executed by the server S, and the generation of the integration distance table and the determination of the user feature amount are executed by the device 10. As a result, communication between the servers S is reduced, and simplification of processing in the server S can be realized.

### (Flow of Third Operation Example)

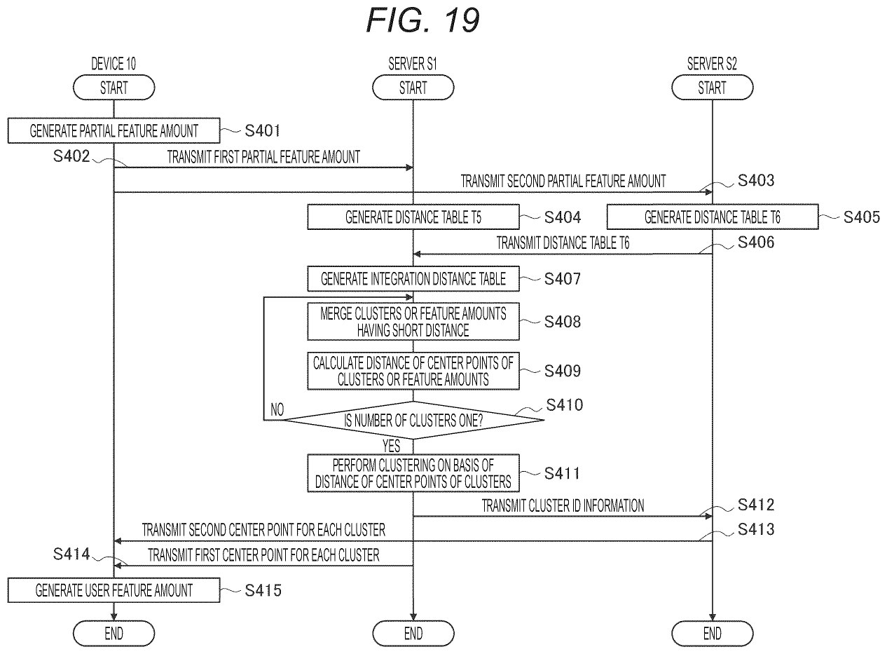

The flow of the third operation example described above will be described with reference to the sequence diagram of FIG. 19. FIG. 19 is a sequence diagram illustrating an example of a flow of the third operation example according to the present embodiment. The sequence diagram of FIG. 19 can be applied as a processing flow of a subroutine of S104 in the flow diagram illustrated in FIG. 2.

First, the device 10 generates the first partial feature amount and the second partial feature amount from the feature amounts (S401). Subsequently, the device 10 transmits the generated first partial feature amount to the server S1 (S402). Further, the device 10 transmits the generated second partial feature amount to the server S2 (S403).

Subsequently, the calculation unit 221 of the server S1 calculates a distance for each combination of the first partial feature amount with another first partial feature amount, and generates the distance table T5 indicating the calculation result (S404).

The calculation unit 221 of the server S2 calculates a distance for each combination of the second partial feature amount with another second partial feature amount, and generates the distance table T6 indicating the calculation result (S405). The communication unit 210 of the server S2 transmits the generated distance table T6 to the server S1 (S406).

The calculation unit 221 of the server S1 calculates an integration distance on the basis of the generated distance table T5 and the distance table T6 received from the server S2 by the communication unit 210, and generates an integration distance table indicating the calculation result (S407).

Subsequently, the calculation unit 221 of the server S1 puts (merges) the two feature amounts included in the combination of the two feature amounts having the shortest integration distance into the same cluster to generate a cluster (S408).

The calculation unit 221 of the server S1 calculates the feature amount or the distance of the center point of the cluster included in the combination for each combination of the two feature amounts not belonging to the cluster, the feature amount not belonging to the cluster and the center point of the cluster, and the center points of the two clusters (S409).

Then, the calculation unit 221 of the server S1 determines whether or not one cluster to which all the feature amounts belong has been generated (S410). In a case where one cluster to which all the feature amounts belong is not generated (S410/NO), the processing returns to S408. The calculation unit 221 of the server S1 repeats the processing of S408 and S409 until one cluster to which all the feature amounts belong is generated.

When one cluster to which all the feature amounts belong is generated (S410/YES), the calculation unit 221 of the server S1 determines final cluster allocation on the basis of the relationship between the distance between the center points of the clusters calculated so far and the predetermined threshold value (S411).

The communication unit 210 of the server S1 transmits cluster ID information indicating the final cluster allocation to the server S2 (S412).

Subsequently, the server S2 calculates a second center point of each cluster. Then, the communication unit 210 of the server S2 transmits the second center point calculated by the calculation unit 221 to the device 10 in association with the cluster ID (S413).

The server S1 calculates a first center point of each cluster. Then, the communication unit 210 of the server S1 transmits the first center point calculated by the calculation unit 221 to the device 10 in association with the cluster ID (S414).

The device 10 determines the user feature amount for each cluster by combining the received first center point and second center point (S415).

### <<4. Hardware Configuration Example>>

Each embodiment of the present disclosure has been described above. The information processing described above is achieved by cooperation of software and hardware. Hereinafter, a hardware configuration example applicable to the device 10 and the server S will be described.

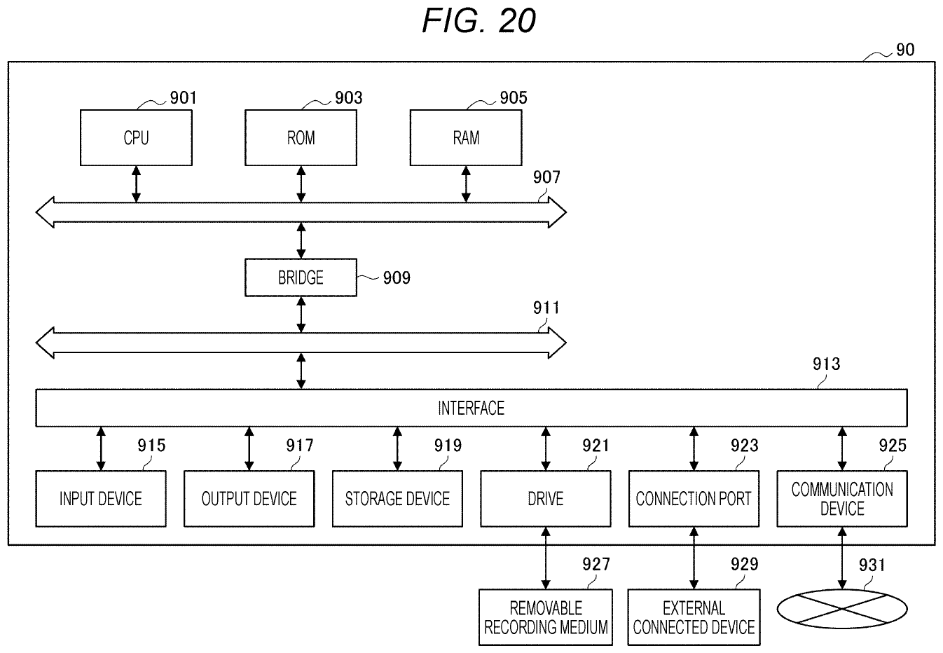

FIG. 20 is a block diagram illustrating an example of the information processing apparatus 90. Note that the hardware configuration example of the information processing apparatus 90 described below is merely an example of the hardware configuration of the device 10 and the server S. Therefore, each of the device 10 and the server S does not necessarily have the entire hardware configuration illustrated in FIG. 20. In addition, a part of the hardware configuration illustrated in FIG. 20 may not exist in the device 10 and the server S.

As illustrated in FIG. 20, the information processing apparatus 90 includes a CPU 901, a read only memory (ROM) 903, and a RAM 905. Furthermore, the information processing apparatus 90 may include a host bus 907, a bridge 909, an external bus 911, an interface 913, an input device 915, an output device 917, a storage device 919, a drive 921, a connection port 923, and a communication device 925. The information processing apparatus 90 may include a processing circuit such as a graphics processing unit (GPU), a digital signal processor (DSP), or an application specific integrated circuit (ASIC) instead of or in addition to the CPU 901.

The CPU 901 functions as an arithmetic processing device and a control device, and controls all or part of the operation in the information processing apparatus 90 in accordance with various programs recorded in the ROM 903, the RAM 905, the storage device 919, or a removable recording medium 927. The ROM 903 stores programs, operation parameters, and the like used by the CPU 901. The RAM 905 temporarily stores a program used in execution of the CPU 901, parameters that change as necessary during the execution, and the like. The CPU 901, the ROM 903, and the RAM 905 are mutually connected by the host bus 907 including an internal bus such as a CPU bus. Moreover, the host bus 907 is connected to the external bus 911 such as a peripheral component interconnect/interface (PCI) bus via the bridge 909.

When the CPU 901 cooperates with the ROM 903, the RAM 905, and software, for example, the function of the control unit 220 can be realized.

The input device 915 is, for example, a device, such as a button, operated by the user. The input device 915 may include a mouse, a keyboard, a touch panel, a switch, a lever, or the like. Furthermore, the input device 915 may include a microphone that detects user's voice. The input device 915 may be, for example, a remote control device using infrared rays or other radio waves, or an external connected device 929 such as a mobile phone adapted to the operation of the information processing apparatus 90. The input device 915 includes an input control circuit that generates an input signal on the basis of information input by the user and outputs the input signal to the CPU 901. By operating the input device 915, the user inputs various kinds of data or gives an instruction to perform a processing operation, to the information processing apparatus 90.

Furthermore, the input device 915 may include an imaging device and a sensor. The imaging device is, for example, a device that generates a captured image by imaging a real space using various members such as an imaging element such as a charge coupled device (CCD) or a complementary metal oxide semiconductor (CMOS), and a lens for controlling image formation of a subject image on the imaging element. The imaging device may capture a still image or may capture a moving image.

Examples of the sensor include various types of sensors, such as a range sensor, an accelerometer, a gyroscope, a geomagnetic sensor, a vibration sensor, a light sensor, and a sound sensor. The sensor acquires, for example, information regarding the state of the information processing apparatus 90 itself, such as a posture of a housing of the information processing apparatus 90, and information regarding the surrounding environment of the information processing apparatus 90, such as brightness and noise around the information processing apparatus 90. Furthermore, the sensor may include a global positioning system (GPS) sensor that receives a GPS signal to measure the latitude, longitude, and altitude of the device.

The output device 917 includes a device that can visually or audibly notify the user of acquired information. The output device 917 may be, for example, a display device such as a liquid crystal display (LCD) or an organic electro-luminescence (EL) display, an audio output device such as a speaker or a headphone, or the like. Furthermore, the output device 917 may include a plasma display panel (PDP), a projector, a hologram, a printer device, or the like. The output device 917 outputs a result of processing performed by the information processing apparatus 90 as a text or visual data such an image, or outputs the result as a sound such as voice or audio. Furthermore, the output device 917 may include a lighting device or the like that brightens the surroundings.

The storage device 919 is a data storage device configured as an example of a storage unit of the information processing apparatus 90. The storage device 919 includes, for example, a magnetic storage device such as a hard disk drive (HDD), a semiconductor storage device, an optical storage device, a magneto-optical storage device, or the like. This storage device 919 stores programs to be executed by the CPU 901 or various kinds of data, various kinds of data acquired from the outside, and the like.

The drive 921 is a reader/writer for the removable recording medium 927 such as a magnetic disk, an optical disc, a magneto-optical disk, or a semiconductor memory and is built in or externally attached to the information processing apparatus 90. The drive 921 reads information recorded in the attached removable recording medium 927 and outputs the information to the RAM 905. Furthermore, the drive 921 writes a record to the attached removable recording medium 927.

The connection port 923 is a port for connecting a device directly to the information processing apparatus 90. The connection port 923 may be, for example, a universal serial bus (USB) port, an IEEE1394 port, a small computer system interface (SCSI) port, or the like. Furthermore, the connection port 923 may be an RS-232C port, an optical audio terminal, a high-definition multimedia interface (HDMI (registered trademark)) port, or the like. By connecting the external connected device 929 to the connection port 923, various kinds of data can be exchanged between the information processing apparatus 90 and the external connected device 929.

The communication device 925 is, for example, a communication interface including a communication device or the like for connecting to a local network or a communication network with a wireless base station. The communication device 925 may be, for example, a communication card for a wired or wireless LAN, Bluetooth (registered trademark), Wi-Fi, or a wireless USB (WUSB). Furthermore, the communication device 925 may be a router for optical communication, a router for asymmetric digital subscriber line (ADSL), a modem for various types of communication, or the like. The communication device 925 transmits and receives signals and the like using a predetermined protocol such as TCP/IP over the Internet or with other communication devices, for example. Furthermore, the local network or the communication network with the base station to which the communication device 925 is connected is a network connected in a wired or wireless manner, and examples of the network include the Internet, a home LAN, infrared communication, radio wave communication, satellite communication, and the like.

### <<5. Additional Notes>>

Although the preferred embodiments of the present disclosure have been described above in detail with reference to the accompanying drawings, the technical scope of the present disclosure is not limited to such an example. It is obvious that those with ordinary skill in the technical field of the present disclosure can conceive various alterations or corrections within the scope of the technical idea recited in the claims, and it is naturally understood that these alterations or corrections also fall within the technical scope of the present disclosure.

For example, in the above embodiment, the example in which the server S1 calculates the integration distance has been described, but the server S2 may calculate the integration distance. On the other hand, in a case where only the server S1 calculates the integration distance, the server S2 may not have the function of calculating the integration distance.

In addition, in the above embodiment, the example in which the number of servers S is two has been mainly described, but the number of servers S may be at least three or more. In this case, each of the plurality of servers S other than the server S1 receives a plurality of second partial feature amounts having different dimensions of feature amount components in the base feature amount from the device 10. Then, each of the plurality of servers S other than the server S1 calculates a second value representing a relationship between the second partial feature amount and a second reference point that is a reference point in the plurality of servers S other than the server S1. The server S1 performs processing for determining the user feature amount on the basis of the integration distance obtained by integrating the first value and the plurality of second values.

Furthermore, in the operation example of the above embodiment, an example in which the user feature amount is determined on the basis of the k-means algorithm and the hierarchical clustering algorithm has been described. However, the algorithm to be used is not limited to this as long as the algorithm performs clustering using a value indicating a similarity relationship between feature amounts. For example, a meanshift algorithm or a spectral clustering algorithm may be used.

In addition, it is also possible to create one or more computer programs for causing hardware such as a CPU, a ROM, and a RAM built in the device 10 and the server S described above to exhibit the functions of the device 10 and the server S. Furthermore, a computer-readable storage medium that stores the one or more computer programs is also provided.

Furthermore, the effects described in the present specification are merely exemplary or illustrative, and not restrictive. In other words, the technology according to the present disclosure can exhibit other effects apparent to those skilled in the art from the description of the present specification, in addition to the effects described above or instead of the effects described above.

Note that the following configurations also fall within the technological scope of the present disclosure.

(1)

A program for causing a computer to function as:
a communication unit that acquires, for each of a plurality of feature amounts, first partial feature amounts including a feature amount component having a same dimension and different from a dimension of a feature amount component included in a second partial feature amount acquired by another information processing apparatus, the second partial feature amount being different from an information processing apparatus configured by the computer; and
a calculation unit that calculates, for each of the plurality of first partial feature amounts acquired by the communication unit, a first value representing a relationship with a first reference point for determining a cluster feature amount that is a feature amount of a cluster of the plurality of feature amounts.
   (2)

The program according to (1), in which the communication unit receives a second value indicating a relationship between the second partial feature amount and a second reference point, the second value being calculated by the another information processing apparatus.

(3)

The program according to (2), in which the calculation unit calculates an integrated value obtained by integrating the first value and the second value.

(4)

The program according to (3), in which
the calculation unit calculates a center point for each cluster of the first partial feature amounts for determining the cluster feature amounts by using the integrated value, and
the communication unit transmits information indicating the center point for each cluster of the first partial feature amounts to a transmission source terminal of the first partial feature amounts.
   (5)

The program according to (4), in which
the calculation unit calculates, for each provisional cluster to which the feature amount temporarily belongs, a first center point that is a center point of the plurality of first partial feature amounts acquired by the communication unit, and
the first reference point is the first center point calculated for each provisional cluster by the calculation unit.
   (6)

The program according to (5), in which
the calculation unit puts each of the feature amounts into the provisional cluster corresponding to the first center point, the provisional cluster indicating that the integrated value corresponding to the first center point is most similar to the feature amount among a plurality of the provisional clusters, and
the communication unit transmits identification information for identifying the provisional cluster to which each of the feature amounts belongs to the another information processing apparatus.
   (7)

The program according to (3) or (4), in which
the calculation unit calculates a plurality of first center points by clustering the first partial feature amounts by a k-means algorithm, the plurality of first center points being center points of the first partial feature amounts for each cluster,
the first reference point is each of the plurality of first center points,
the communication unit receives, from the another information processing apparatus, a plurality of second values representing a relationship between each of a plurality of second center points and each of the second partial feature amounts, the plurality of second center points being center points for each cluster to which the second partial feature amount belongs, the second partial feature amount including a feature amount component having a dimension in the feature amount different from a dimension of the first partial feature amount, and
the calculation unit further determines a combination for determining the cluster feature amount from combinations of the first center points and the second center points.
   (8)

The program according to (7), in which
the calculation unit
calculates the integrated value for each combination of the first center point and the second center point for each of the feature amounts, and determines a combination of the integrated values indicating that the first center point and the second center point have the most similar relationship as a combination in the feature amount, and
determines the combination having the largest number of combinations determined as the combination in the feature amount as the combination for determining the cluster feature amount.
   (9)

The program according to (3) or (4), in which the calculation unit calculates the first value for each combination with another first partial feature amounts by using each of the another first partial feature amounts as the first reference point for each first partial feature amount.

(10)

The program according to (9), in which
the calculation unit calculates the integrated value of the first value and a second value calculated on the basis of two second partial feature amounts having the same base two feature amounts as two of the first partial feature amounts corresponding to the first value, and determines whether or not to put the two feature amounts into the same cluster on the basis of a magnitude of the integrated value.
   (11)

The program according to any one of (3) to (10), in which
the first value is a Euclidean distance between the first partial feature amount and the first reference point,
the second value is a Euclidean distance between the second partial feature amount and the second reference point, and
the calculation unit calculates the integrated value by adding the first value and the second value.
   (12)

The program according to any one of (2) to (11), in which the communication unit receives the second value from each of a plurality of the another information processing apparatuses.

(13)

An information processing apparatus including:
a communication unit that acquires, for each of a plurality of feature amounts, first partial feature amounts including a feature amount component having a same dimension and different from a dimension of a feature amount component included in a second partial feature amount acquired by another information processing apparatus; and
a calculation unit that calculates, for each of the plurality of first partial feature amounts acquired by the communication unit, a first value representing a relationship with a first reference point for determining a cluster feature amount that is a feature amount of a cluster of the plurality of feature amounts.
   (14)

An information processing method executed by a computer, the method including:
acquiring, for each of a plurality of feature amounts, first partial feature amounts including a feature amount component having a same dimension and different from a dimension of a feature amount component included in a second partial feature amount acquired by another information processing apparatus, the second partial feature amount being different from an information processing apparatus configured by the computer; and
calculating, for each of the plurality of first partial feature amounts acquired, a first value representing a relationship with a first reference point for determining a cluster feature amount that is a feature amount of a cluster of the plurality of feature amounts.

### REFERENCE SIGNS LIST

S Server
10 Device
30 Network
210 Communication unit
220 Control unit
221 Calculation unit
230 Storage unit

1. A program for causing a computer to function as:
a communication unit that acquires, for each of a plurality of feature amounts, first partial feature amounts including a feature amount component having a same dimension and different from a dimension of a feature amount component included in a second partial feature amount acquired by another information processing apparatus, the second partial feature amount being different from an information processing apparatus configured by the computer; and
a calculation unit that calculates, for each of the plurality of first partial feature amounts acquired by the communication unit, a first value representing a relationship with a first reference point for determining a cluster feature amount that is a feature amount of a cluster of the plurality of feature amounts.

2. The program according to claim 1, wherein the communication unit receives a second value indicating a relationship between the second partial feature amount and a second reference point, the second value being calculated by the another information processing apparatus.

3. The program according to claim 2, wherein the calculation unit calculates an integrated value obtained by integrating the first value and the second value.

4. The program according to claim 3, wherein
the calculation unit calculates a center point for each cluster of the first partial feature amounts for determining the cluster feature amounts by using the integrated value, and
the communication unit transmits information indicating the center point for each cluster of the first partial feature amounts to a transmission source terminal of the first partial feature amounts.

5. The program according to claim 3, wherein
the calculation unit calculates, for each provisional cluster to which the feature amount temporarily belongs, a first center point that is a center point of the plurality of first partial feature amounts acquired by the communication unit, and
the first reference point is the first center point calculated for each provisional cluster by the calculation unit.

6. The program according to claim 5, wherein
the calculation unit puts each of the feature amounts into the provisional cluster corresponding to the first center point, the provisional cluster indicating that the integrated value corresponding to the first center point is most similar to the feature amount among a plurality of the provisional clusters, and
the communication unit transmits identification information for identifying the provisional cluster to which each of the feature amounts belongs to the another information processing apparatus.

7. The program according to claim 3, wherein
the calculation unit calculates a plurality of first center points by clustering the first partial feature amounts by a k-means algorithm, the plurality of first center points being center points of the first partial feature amounts for each cluster,
the first reference point is each of the plurality of first center points,
the communication unit receives, from the another information processing apparatus, a plurality of second values representing a relationship between each of a plurality of second center points and each of the second partial feature amounts, the plurality of second center points being center points for each cluster to which the second partial feature amount belongs, the second partial feature amount including a feature amount component having a dimension in the feature amount different from a dimension of the first partial feature amount, and
the calculation unit further determines a combination for determining the cluster feature amount from combinations of the first center points and the second center points.

8. The program according to claim 7, wherein
the calculation unit
calculates the integrated value for each combination of the first center point and the second center point for each of the feature amounts, and determines a combination of the integrated values indicating that the first center point and the second center point have the most similar relationship as a combination in the feature amount, and
determines the combination having the largest number of combinations determined as the combination in the feature amount as the combination for determining the cluster feature amount.

9. The program according to claim 3, wherein the calculation unit calculates the first value for each combination with another first partial feature amounts by using each of the another first partial feature amounts as the first reference point for each first partial feature amount.

10. The program according to claim 9, wherein
the calculation unit calculates the integrated value of the first value and a second value calculated on a basis of two second partial feature amounts having the same base two feature amounts as two of the first partial feature amounts corresponding to the first value, and
determines whether or not to put the two feature amounts into the same cluster on a basis of a magnitude of the integrated value.

11. The program according to claim 3, wherein
the first value is a Euclidean distance between the first partial feature amount and the first reference point,
the second value is a Euclidean distance between the second partial feature amount and the second reference point, and
the calculation unit calculates the integrated value by adding the first value and the second value.

12. The program according to claim 2, wherein the communication unit receives the second value from each of a plurality of the another information processing apparatuses.

13. An information processing apparatus comprising:
a communication unit that acquires, for each of a plurality of feature amounts, first partial feature amounts including a feature amount component having a same dimension and different from a dimension of a feature amount component included in a second partial feature amount acquired by another information processing apparatus; and
a calculation unit that calculates, for each of the plurality of first partial feature amounts acquired by the communication unit, a first value representing a relationship with a first reference point for determining a cluster feature amount that is a feature amount of a cluster of the plurality of feature amounts.

14. An information processing method executed by a computer, the method comprising:
acquiring, for each of a plurality of feature amounts, first partial feature amounts including a feature amount component having a same dimension and different from a dimension of a feature amount component included in a second partial feature amount acquired by another information processing apparatus, the second partial feature amount being different from an information processing apparatus configured by the computer; and
calculating, for each of the plurality of first partial feature amounts acquired, a first value representing a relationship with a first reference point for determining a cluster feature amount that is a feature amount of a cluster of the plurality of feature amounts.
